(19) United States
(12) Patent Application Publication
(10) Pub. No.: US 2009/0019177 A1
(43) Pub. Date: Jan. 15, 2009

(54) SECURE CONTENT CASTING NETWORK

(75) Inventors: Vikram Dham, Brentwood, TN (US); Brad Edmonson, Franklin, TN (US)

Correspondence Address: GREENBERG TRAURIG, LLP, 2101 L Street, N.W., Suite 1000, Washington, DC, 20037, US

(73) Assignee: PassAlong Networks,LLC, Franklin, TN (US)

(21) Appl. No.: 12/027,678

(22) Filed: Feb. 7, 2008

Related U.S. Application Data
(60) Provisional application No. 60/888,627, filed on Feb. 7, 2007.

(51) Int. Cl. G06F 15/16

(52) U.S. Cl. 709/232

(57) ABSTRACT

A system and method for transmitting content on a peer-to-peer network. A content item a content provider and divided into a plurality of content segments. Each of the content segments is encrypted and dividing into at least one content segment stripe. Each of the content segment stripes are transmitted one of a plurality of nodes on the peer-to-peer network, wherein substantially all of the content segment stripes are transmitted to different nodes on the peer-to-peer network for retransmission substantially in parallel to a second node on the peer-to-peer network.

This application claims the benefit of U.S. Provisional Application Ser. No. 60/888,627 filed Feb. 7, 2007, the entire disclosure of which is hereby incorporated by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The instant disclosure relates to systems and methods for streaming large, high quality digital media content to a plurality of devices in a Peer-to-Peer (“P2P”) network using multiple parallel data flows.

### BACKGROUND OF THE INVENTION

Traditionally P2P networks have been used for passive file downloading. Files distributed through these P2P networks are available for use by the end user only after the file has been downloaded in its entirety. In P2P networks the available end to end bandwidth is limited to the minima of upload bandwidth at the uploading endpoint and download bandwidth at the destination endpoint. Various P2P networks attempt to solve this problem by segmenting the files into smaller segments. The segments are delivered to the end user in random order and re-assembled in their original order before being made available to the user.

Traditional P2P networks are well suited for passive file downloads but do not adequately meet the requirements for streaming high quality content such as large video files. Furthermore, traditional P2P networks are typically implemented in software on a computer device. A plurality of non-PC consumer electronic devices for example, e.g., DVD players or digital cameras, exist that can benefit from being able to stream large, high quality digital media content from a P2P network. Unfortunately, the software implementation of traditional P2P networks may preclude non-PC consumer electronic devices from interacting with traditional P2P networks.

### SUMMARY OF THE INVENTION

In one embodiment, the invention is directed to a method and a computer readable medium having computer-executable instructions for implementing a method for transmitting content on a peer-to-peer network. A content item a content provider and divided into a plurality of content segments. Each of the content segments is encrypted and dividing into at least one content segment stripe. Each of the content segment stripes are transmitted one of a plurality of nodes on the peer-to-peer network, wherein substantially all of the content segment stripes are transmitted to different nodes on the peer-to-peer network for retransmission substantially in parallel to a second node on the peer-to-peer network.

In another embodiment, the invention is directed to a system for transmitting content on a peer-to-peer network. The system includes: a content input module that receives a content item from a content provider; a content segmentation module that divides the content item into a plurality of content segments; a content segment encryption module that encrypts each of the of content segments; a content segment striping module that divides each of the encrypted content segments into at least one content segment stripe; and a content segment stripe output module that transmits each content segment stripes to one of a plurality of nodes on the peer-to-peer network wherein substantially all of the content segment stripes are transmitted to a different node on the peer-to-peer network for retransmission substantially in parallel to a second node on the peer-to-peer network.

In another embodiment, the invention is directed to a method and a computer readable medium having computer-executable instructions for implementing a method for receiving content on a node in a peer-to-peer network. A request for a content item is received from an end user. A content profile for the content item is retrieved from a secure content directory, wherein the content profile contains information relating to the location of a plurality of content segment stripes, each of which comprises a portion of the content item in encrypted form, each of the plurality of content segment stripes being located on a node in the peer-to-peer network. A plurality of parallel data flows for retrieving content segment stripes are established. A plurality of stripe queues for receiving the parallel data flows are established. The content segment stripes are retrieved into the stripe queues substantially concurrently and are decrypted and passed to a player queue where the content segment stripes are reassembled into at least one content segment.

In another embodiment, the invention is directed to a node in a peer-to-peer network. The system includes: an input interface module that receives a request for a content item from an end user; a content manager module that retrieves a content profile for the content item from a secure content directory, wherein the content profile contains information relating to the location of a plurality of content segment stripes, each of which comprises a portion of the content item in encrypted form, each of the plurality of content segment stripes being located on a node in the peer-to-peer network; a segment manager module that establishes a plurality of parallel data flows for retrieving the content segment stripes from the nodes on which each of the stripes is located; a reassembly module that creates a plurality of stripe queues for receiving the plurality of parallel data flows and retrieves the plurality of content segment stripes into stripe queues substantially concurrently; a decryption module that decrypts the content segment stripes and passes the decrypted content segment stripes to a player queue wherein the content segment stripes are reassembled into at least one content segment.

### BRIEF DESCRIPTION OF THE DRAWINGS

The accompanying drawings, which are included to provide a further understanding of the disclosed secure content casting network and are incorporated in and constitute a part of this specification, illustrate various embodiments and, together with the description, serve to explain the principles of at least one embodiment of the disclosed secure content casting network.

FIG. 1 a high-level illustration of an embodiment of a system and architecture suitable for practicing at least one embodiment of the present invention.

FIG. 2 is a block diagram illustrating one embodiment of a process wherein content into is divided into content segments and stripes.

FIG. 3 is a block diagram illustrating one embodiment of a process wherein a segment demultiplexing updates a unit secure content directory with content segment and stripe information.

FIG. 4 is a block diagram of one embodiment of a content segment manager.

FIG. 5 is a block diagram of one embodiment of a segment demultiplexing unit FIG. 6 is a block diagram of one embodiment of a secure content node.

### DETAILED DESCRIPTION

The present invention is described below with reference to block diagrams and operational illustrations of systems and methods for streaming large, high quality digital media content to a plurality of devices in a Peer-to-Peer (“P2P”) network It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” or “system” should be understood to refer to a service point which provides processing, database, and communication facilities. By way of example, and not limitation, the term “server” or “system” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “media” and “content” should be understood to refer to binary data which contains content which can be interest to an end user. By way of example, and not limitation, the term “media” and “content” can refer to multimedia data, such as video data or audio data, or any other form of data capable of being transformed into a form perceivable by an end user. Such data can, furthermore, be encoded in any manner currently known, or which can be developed in the future, for specific purposes. By way of example, and not limitation, the data can be further encrypted, compressed, and/or can contained embedded metadata.

For the purposes of this disclosure the term “stream” and “data stream” should be understood to refer to a stream of binary data between a data source and a data consumer. The data can be consumed as it is received by the data consumer (i.e. “real-time” or “near time”, or can be stored for later consumption. The stream can be continuous, or subject to period interruption. By way of example, and not limitation, the term “stream” and “data stream” can refer to a stream of media content, such as music, video, or audio video data. Such data can, furthermore, be encoded in any manner currently known, or which can be developed in the future, for specific purposes. By way of example, and not limitation, the data can be encrypted, compressed, and/or can contained embedded metadata.

For the purposes of this disclosure a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. A module or a component of a module implemented as software or firmware may be stored on a computer readable medium.

Reference will now be made in detail to illustrative embodiments of the present invention, examples of which are shown in the accompanying drawings.

The embodiments discussed below generally relate systems and methods for securely streaming large, high quality digital media content to a plurality of connected consumers in a peer-to-peer network capable of supporting multiple types of peer devices, including small consumer electronic devices with limited resources. High quality content is efficiently distributed in the secure content casting network by dividing the content into content segments. Content segments may be further divided into a plurality of content segment stripes and stored across a plurality of secure content nodes within the secure content casting network. A destination endpoint receives the content by establishing multiple parallel data flows with different secure content nodes whereby the bandwidth utilized to transfer the content is maximized.

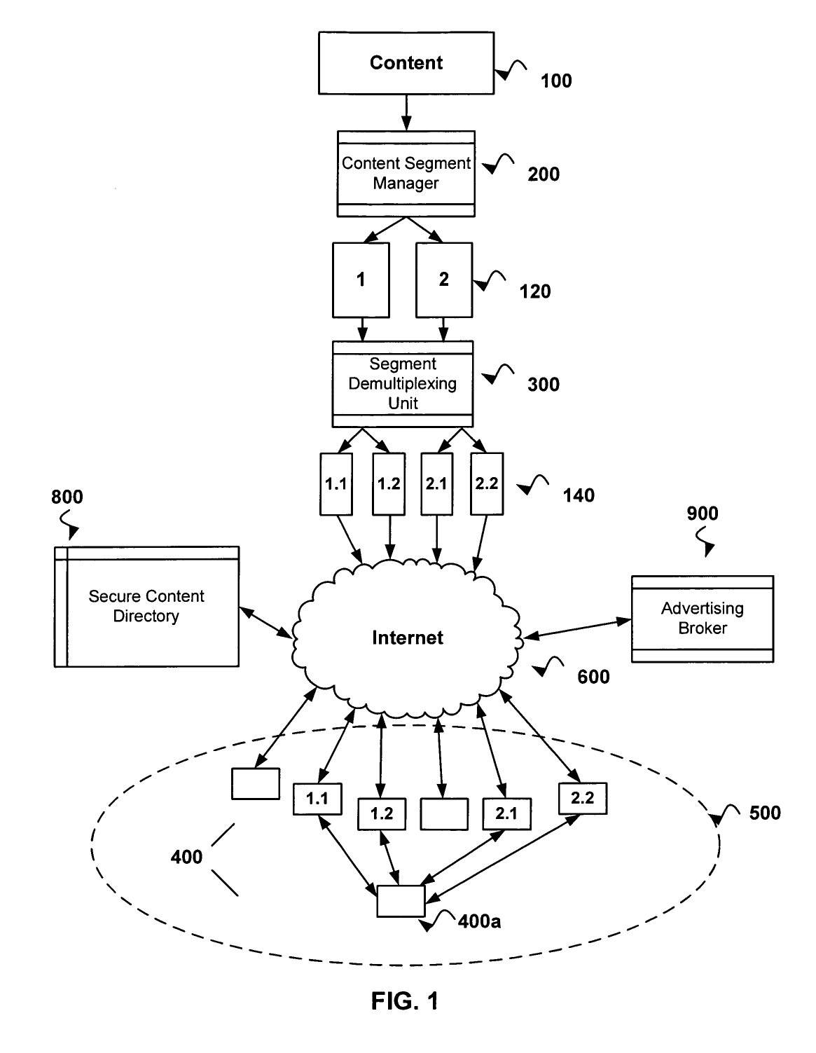

FIG. 1 a high-level illustration of an embodiment of a system and architecture suitable for practicing at least one embodiment of the present invention. A content item 100, such as a streaming media clip, is received and is divided into segments 120 by a content manager 200. Each segment is further divided into content segment stripes 140 by a segment demultiplexing unit 300. The content segment stripes 140 are transmitted to secure content nodes 400 within in a peer-to-peer network 500 over an external network 600, for example, the Internet. In one embodiment, each stripe is transmitted to, and stored on, a different node 400 within in the peer-to-peer network 500. A profile for the content item 100 is added to a secure content directory 800 which identifies the location of all the segment stripes 140 of the content item.

If a given node 400a within the peer-to-peer network 500 wishes to view the content item 100, the node obtains the address of nodes 400 within the network which store the content segment stripes 140 of the content item 100 from the secure content directory 800. The node 400a may then setup multiple parallel data flows to each of the other nodes to obtain all the segments of the content item 100. Additionally, the 400a may download advertisements from an advertising broker 900 for inclusion with the downloaded content item 100. Each of the elements described above will now be discussed in more detail below

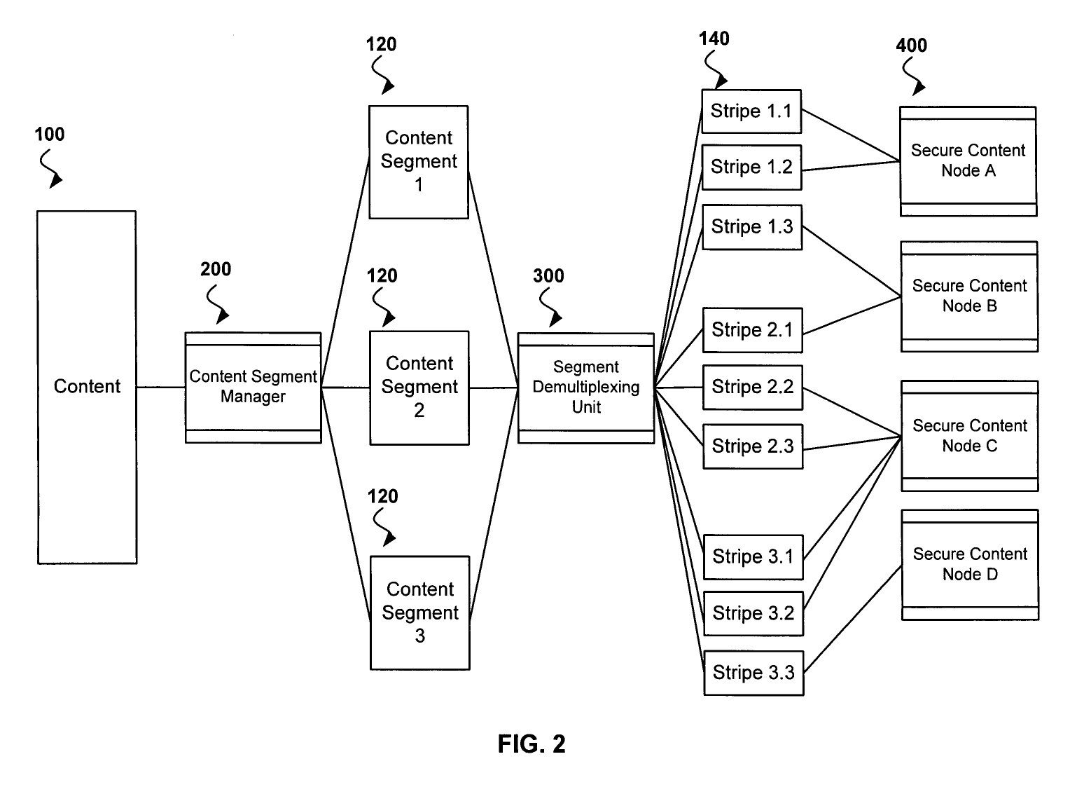

FIG. 2 is a block diagram illustrating one embodiment of a process wherein content into is divided into content segments and stripes. A content segment manager 200 receives content 100, for example, streaming media, from a content provider and divides the content into a plurality of smaller content segments 120. The content segments 120 may be of uniform or differing size. Each content segment 120 may contain data from a contiguous range within the content 100, or may contain data from multiple locations within the content. In one embodiment, the content segment manager 200 generates a unique segment identifier 122 (not shown in FIG. 1, see FIG. 2) for each content segment 120. The content segment manager 200 may further encrypt each content segment 120 using one of the widely available encryption algorithms such as, e.g., AES, 3DES, etc. The content segment manager 200 may further compress all or a portion of each content segment 120 using any industry standard compression algorithm.

In one embodiment, content segments 120 may be sent to a segment demultiplexing unit 300 that further divides each content segment 120 into a plurality of content stripes 140. The content segments 120 may be of uniform or differing size. Each content segment stripe 140 may comprise data from a contiguous range within the content segment 120, or may contain data from multiple locations within the content segment. The content stripes 140 may then be transmitted to secure content nodes 400 within a peer-to-peer network which may store the content stripes for transmission to other nodes or consumption at the receiving node or both.

In one embodiment, the number of content segment stripes 140 created depends the available storage capacity of the target secure content nodes 400. If the available storage capacity is large, the content segment 120 is not divided into multiple content segment stripes 140. In one embodiment, an individual node 400 stores a single content stripe 140. Alternatively, an individual node 400 may store multiple content stripes 140 for single or multiple content segments 120 which may further relate to single or multiple content items 100. A given content stripe 140 may be stored on single or multiple nodes 400. Additional content segment stripes 140 may be created later as required by changes in the composition of the secure content casting network.

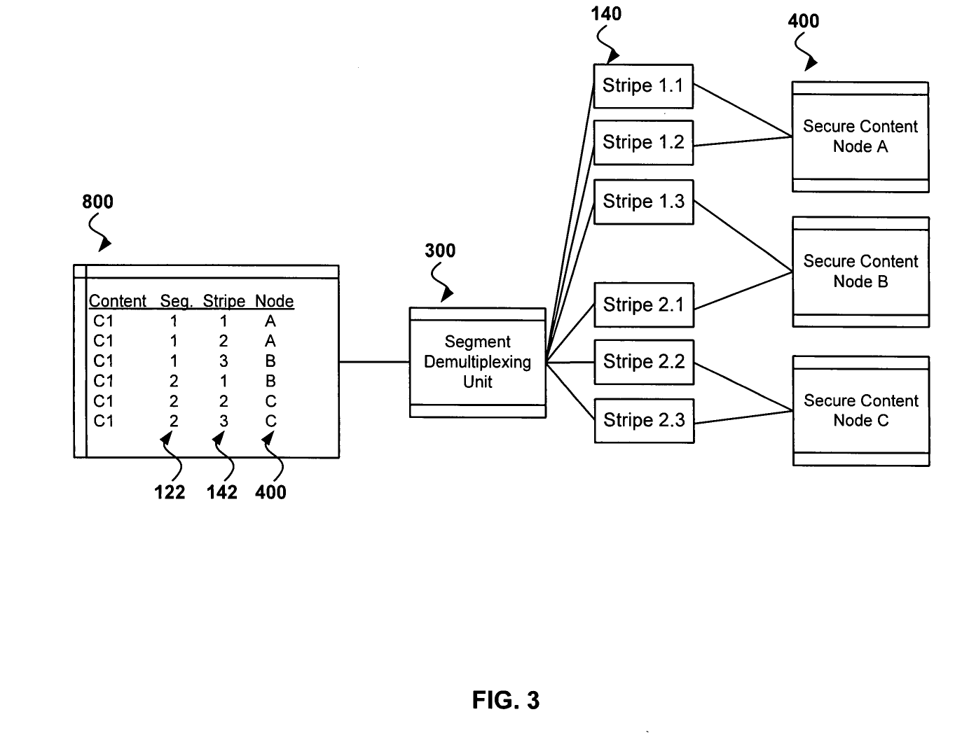

Referring next to FIG. 3, when the segment demultiplexing unit 300 creates content segment stripes 140, each content stripe may be assigned a unique content stripe identifier 142. In one embodiment, the unique content segment identifier 122 and content segment stripe identifier 142 for every content segment stripe 140 are stored in a secure content directory 800. The secure content directory 800 may be further updated to reflect the node or nodes 400 on which a given content stripe 140 is stored. In one embodiment of the secure content directory 800, individual content item, such as media clips, each have a unique profile. In one embodiment, the profile is stored in Extensible Markup Language (“XML”). One embodiment of such an XML document is as follows.

<CP id=″″>

<META-DATA>
<TITLE></TITLE>
<GENRE></GENRE>
</META-DATA>
<SP id=″″ duration=″″ decrypt-key=″″>

<keywords></keywords>
<SSP ssid=″″ ></SSP>
<SSP ssid=″″ ></SSP>
<SSP ssid=″″ ></SSP>

</SP>
<SP id=″″ duration=″″ decrypt-key=″″>

<keywords></keywords>
<SSP ssid=″″ ></SSP>
<SSP ssid=″″ ></SSP>
<SSP ssid=″″ ></SSP>

</SP>

</CP>

In the embodiment shown above, a given content item, <CP></CP>, has a content profile ID, metadata, which may include a title and a genre, and one or more segments <SP></SP> which may include a segment ID, a duration, a decryption key, one or more advertising keywords, and one or more segment stripes. It will be obvious to those skilled in the art that the content profile may be stored in a format other than XML without significantly departing from spirit and scope of the invention.

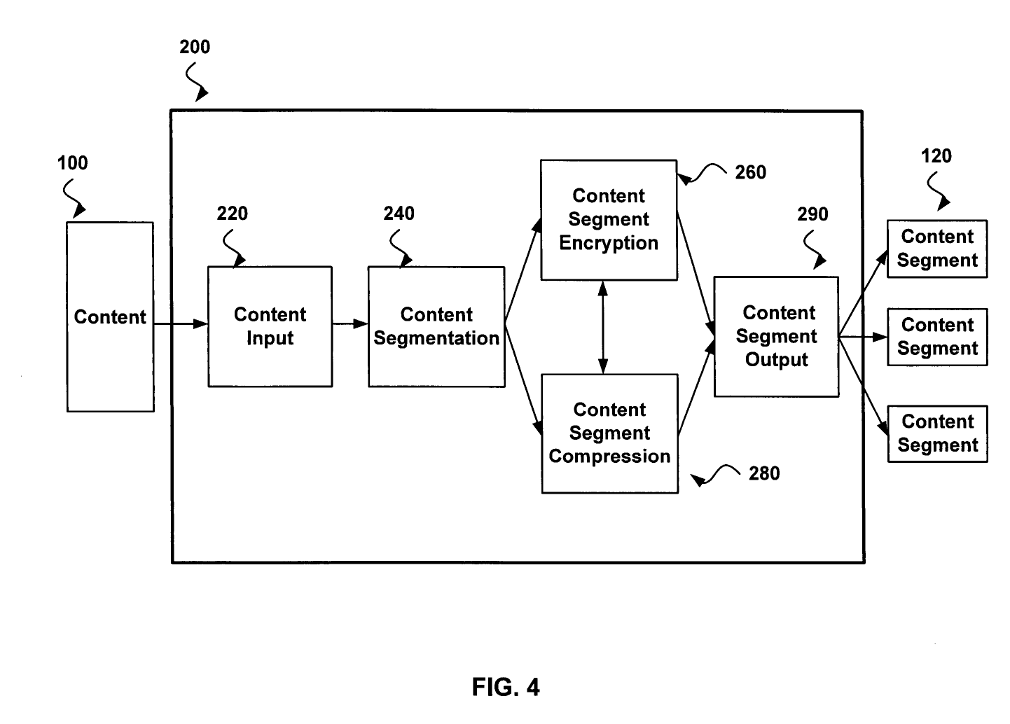

FIG. 4 is a block diagram of one embodiment of a content segment manager 200. The content segment manager 200 includes a content input module 220 which receives content 100, such as, for example, streaming media, from an external source, such as, for example, another server. The content segment manager further includes a content segmentation module 240 that segments content 100 into a plurality of segments with segment ID's. The content segment manager 200 further includes a content segment encryption module 260 that encrypts all, or a portion of, each segments 120. The content segment manager 200 may further include a content segment compression module 280 to compress all or a portion of each content segment 120 using an industry standard compression algorithm. The content segment manager 200 further includes a content segment output module 290 that outputs the content data segments 120, which, in one embodiment, are input to a segment demultiplexing unit.

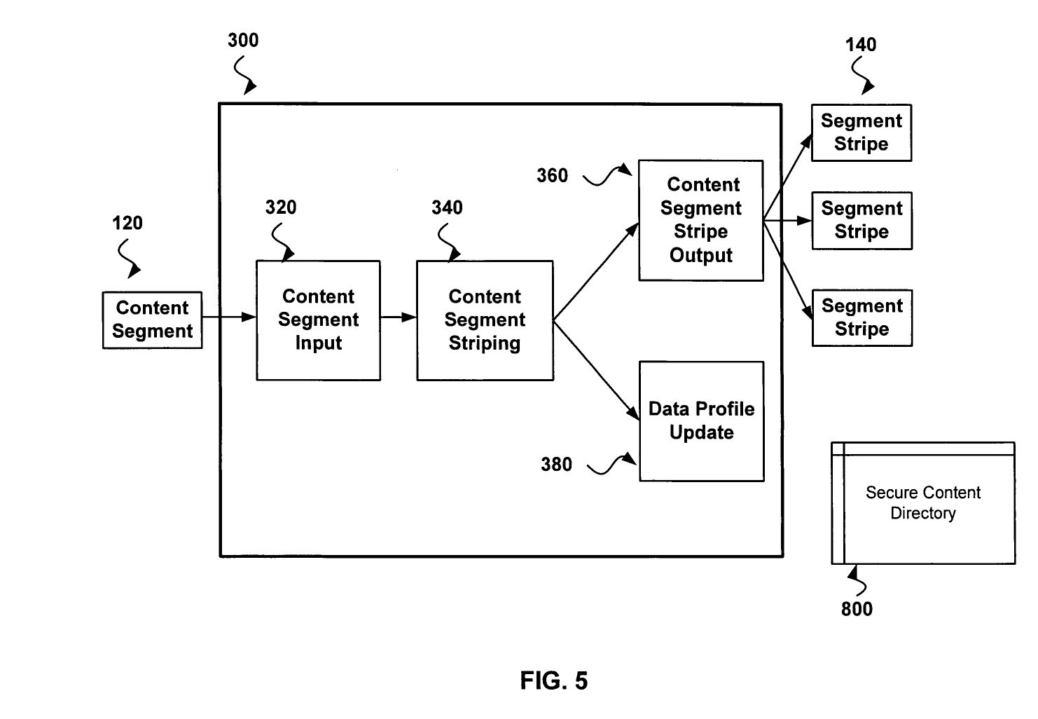

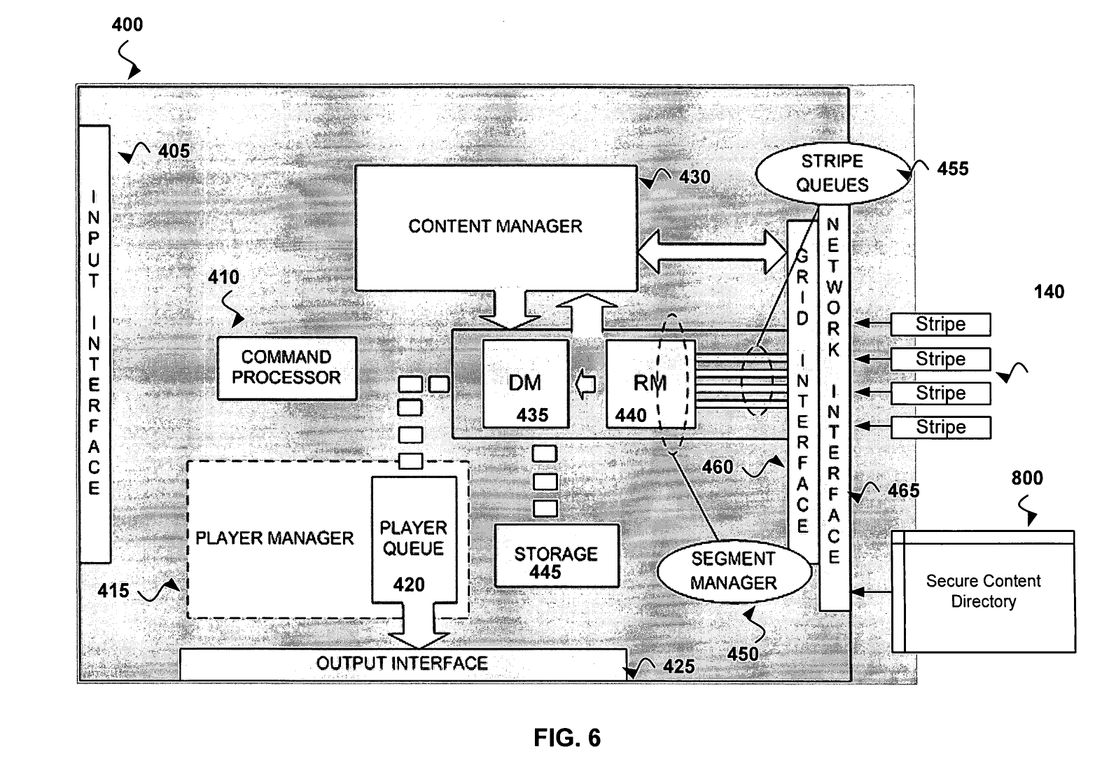

FIG. 5 is a block diagram of one embodiment of a segment demultiplexing unit 300. The segment demultiplexing unit 300 includes a content segment input module 320 which receives content segments 120 of a content item 100, such as, for example, one or more segments of streaming media. The segment demultiplexing unit 300 further includes a content segment striping module 340 that divides content segments 120 into one to many segment stripes with segment stripe IDs. The content segment manager 200 further includes a content segment stripe output module 360 that outputs the content data segment stripes, which, in one embodiment, are transmitted to secure content nodes. The segment demultiplexing unit further includes a data profile update module 380 that updates a profile stored on a secure content directory 800 for the content item 100. In one embodiment, the profile for the content item 100 contains information including, the name and type of the content item, the segments the content has been divided into, the encryption applied to specific segments, the content segment stripes comprising each segment, and the location on specific secure content nodes of each content segment stripe.

The content segment manager 200, the segment demultiplexing unit 300, and the secure content directory 800 may each be hosted on, without limitation, a server of the content provider, a third party service provider, or a control server of a hybrid peer-to-peer network. The content segment manager 200 and the segment demultiplexing unit 300 and content directory 800 may reside on the same server, or alternatively, may be distributed across any number of systems or servers in any configuration well known to those skilled in the art. Content processed by the content segment manager 200 and the segment demultiplexing unit 300 may originate with the provider of the content segment manager or the segment demultiplexing unit or may originate with a third party.

FIG. 6 is a block diagram of one embodiment of a secure content node 400. The secure content node may be a PC or a non-PC device connected to the secure content casting network. The modules of the secure content node 400 as described below may be implemented using any combination of hardware or software best suited to the target platform. In the case of non-PC devices, such as DVD players, digital cameras, PDA's, cell phones and other small lightweight devices with limited processing capability, secure content node functionality may be implemented using compact, standalone modules that do not require a general purpose computer or operating system services of a complex operating system such as Windows. Methods of implementing the modules described below into small, inexpensive personal electronic devices will be obvious to those skilled in the art, and are intended to be encompassed by the scope of this disclosure.

In the illustrated embodiment, the secure content node 400 comprises: an input interface module 405, a command processor 410, a player manager module 415 with a player queue 420, an output interface module 425, a content manager module 430, a storage device 445, a segment manager module 450, a grid interface module 460, and a network interface module 465. The segment manager may further comprise: a decryption module 435, a re-assembly module 440, and a plurality of stripe queues 455. As will be recognized by those of ordinary skill in the art, the secure content node may further comprise additional functions without departing from the spirit and scope of the invention.

The input interface module 405 may receive requests for content, for example, from an end user. The content manager module 430 retrieves the appropriate content profile from the secure content directory 800 over a secure connection. The content profile is used by the segment manager 450 to establish multiple parallel data flows whereby the content segment stripes of the requested content are concurrently retrieved from a plurality of secure content nodes within the secure content casting network.

The content manager module 430 may further control the player queue 420, and may further log and communicate information to a central reporting and analysis framework within, for example, a service provider that provides content segment management services. The re-assembly module 440 uses the content profile to create the plurality of stripe queues 455 that retrieve the content segment stripes concurrently from different secure content nodes within the secure content casting network. The decryption module 435 may be used to decrypt the content segment stripes when they are encrypted before passing them to the player queue 420 wherein the content segment stripes are reassembled into at least one content segment. The segment stripes may also be stored locally in the storage device 445 for subsequent playback. The player manager module 415 controls the player queue 420 and outputs the requested content to the output interface 425.

The secure content node 400 may additionally contain an advertising insertion module (not shown). The advertising insertion module may use meta-data information contained in a content item's profile, for example, keywords associated with a segment, to locate contextually relevant advertising inventory. The advertising insertion module passes meta-data information to an available advertising broker (see, e.g. FIG. 1, 900) to retrieve relevant advertising information for insertion into a content segment.

In one embodiment the secure content casting network may further comprise an advertising broker network. The advertising broker network may comprise a web application architecture allowing the buying and placement of advertisements to be done via the Internet. The advertising broker network enables interaction between buyers interested in placing their advertisements and sellers soliciting advertising revenue for their content. In one embodiment of the advertising broker network, buyers and sellers may determine advertisement placement pricing through a bidding process. In another embodiment of the advertising broker network, buyers can pick advertisement placement based on information communicated from the secure content nodes to the central reporting and analysis framework.

In one embodiment a secure content casting network as described above may further comprise a means of allowing secure content nodes 400 to choose whether or not to contribute upload bandwidth to the secure content casting network. Secure content nodes 400 may be given incentives to contribute upload bandwidth, for example, such nodes may be charged lower rates to access high quality content. Such a feature may be implemented by, for example, maintaining user profiles for individual nodes on a server which implements a segment demultiplexing unit. The segment demultiplexing unit would only transmit segment stripes for storage or retransmission to nodes which have previously agreed to contribute upload bandwidth. In another example, such a feature could be implemented principally at the secure content node, whereby the node refuses to accept the transmission of a content data for storage or retransmission.

While detailed and specific embodiments of the secure content casting network have been described herein, it will be apparent to those skilled in the art that various changes and modifications can be made therein without departing from the spirit and scope of the invention. Thus, it is intended that the present disclosure cover these modifications and variations provided they come within the scope of any appended claims and/or their equivalents.

We claim:

1. A method for transmitting content on a peer-to-peer network, comprising the steps:
receiving a content item from a content provider;
dividing the content item into a plurality of content segments;
encrypting each of the plurality of content segments;
dividing each of the plurality of encrypted content segments into at least one content segment stripe;
transmitting each of the at least one content segment stripes to one of a plurality of nodes on the peer-to-peer network,
wherein substantially all of the content segment stripes are transmitted to different nodes on the peer-to-peer network for retransmission substantially in parallel to a second node on the peer-to-peer network.

2. The method of claim 1 wherein the second node is a small non-PC electronic device with limited processing capability.

3. The method of claim 2 wherein the second node is selected from the list: DVD player, digital camera, PDA, cell phone.

4. The method of claim 1 comprising the additional step of updating a secure content directory with information relating to each of the at least one content segment stripes, wherein the information enables the second node on the peer-to-peer network to locate each of the at least one content segment stripes.

5. The method of claim 1 comprising the additional step of compressing the content segment.

6. A computer-readable medium having computer-executable instructions for a method for transmitting content on a peer-to-peer network, comprising the steps:
receiving a content item from a content provider;
dividing the content item into a plurality of content segments;
encrypting each of the plurality of content segments;
dividing each of the plurality of encrypted content segments into at least one content segment stripe;
transmitting each of the at least one content segment stripes to one of a plurality of nodes on a peer-to-peer network,
wherein substantially all of the content segment stripes are transmitted to different nodes on the peer-to-peer network for retransmission substantially in parallel to a second node on the peer-to-peer network.

7. The computer-readable medium of claim 5 wherein the second node is a small non-PC electronic device with limited processing capability.

8. The computer-readable medium of claim 6 wherein the second node is selected from the list: DVD player, digital camera, PDA, cell phone.

9. The computer-readable medium of claim 5 comprising the additional step of updating a secure content directory with information relating to each of the at least one content segment stripes, wherein the information enables the second node on the peer-to-peer network to locate each of the at least one content segment stripes.

10. The computer-readable medium of claim 5 comprising the additional step of compressing the content segment.

11. A system for transmitting content on a peer-to-peer network, comprising the steps:
a content input module that receives a content item from a content provider;
a content segmentation module that divides the content item into a plurality of content segments;
a content segment encryption module that encrypts each of the plurality of content segments;
a content segment striping module that divides each of the plurality of encrypted content segments into at least one content segment stripe;
a content segment stripe output module that transmits each of the at least one content segment stripes to one of a plurality of nodes on the peer-to-peer network.
wherein substantially all of the content segment stripes are transmitted to different node on the peer-to-peer network for retransmission substantially in parallel to a second node on the peer-to-peer network.

12. The system of claim 11 wherein the second node is a small non-PC electronic device with limited processing capability.

13. The system of claim 12 wherein the second node is selected from the list: DVD player, digital camera, PDA, cell phone.

14. The system of claim 11 additionally comprising a data profile update module that updates a secure content directory with information relating to each of the at least one content segment stripes, wherein the information enables the second node on the peer-to-peer network to locate each of the at least one content segment stripes.

15. The system of claim 11 additionally comprising a content segment compression module that compresses the content segment.

16. A method for receiving content on a node in a peer-to-peer network comprising the steps:
receiving a request for a content item from an end user;
retrieving a content profile for the content item from a secure content directory, wherein the content profile contains information relating to the location of a plurality of content segment stripes, each of which comprises a portion of the content item in encrypted form, each of the plurality of content segment stripes being located on a node in the peer-to-peer network;
establishing a plurality of parallel data flows for retrieving the plurality of content segment stripes from the nodes on which of each the plurality of content segment stripes is located;
creating a plurality of stripe queues for receiving the plurality of parallel data flows;
retrieving the plurality of content segment stripes into the plurality of stripe queues substantially concurrently;
decrypting the content segment stripes;
passing the decrypted content segment stripes to a player queue wherein the content segment stripes are reassembled into at least one content segment.

17. The method of claim 16 comprising the additional step of inserting advertising content from a into the at least one content segment.

18. The method of claim 16 comprising the additional step of storing the decrypted content segment stripes in a storage device.

19. The method of claim 16 comprising the additional step of logging and communicating information to a central reporting and analysis framework

20. A computer-readable medium having computer-executable instructions for a method for a method for receiving content on a node in a peer-to-peer network comprising the steps:
receiving a request for a content item from an end user;
retrieving a content profile for the content item from a secure content directory, wherein the content profile contains information relating to the location of a plurality of content segment stripes, each of which comprises a portion of the content item in encrypted form, each of the plurality of content segment stripes being located on a node in the peer-to-peer network;
establishing a plurality of parallel data flows for retrieving the plurality of content segment stripes from the nodes on which each of the plurality of content segment stripes is located;
creating a plurality of stripe queues for receiving the plurality of parallel data flows;
retrieving the plurality of content segment stripes into the plurality of stripe queues substantially concurrently;
decrypting the content segment stripes;
passing the decrypted content segment stripes to a player queue wherein the content segment stripes are reassembled into at least one content segment.

21. The computer-readable medium of claim 20 comprising the additional step of inserting advertising content from a into the at least one content segment.

22. The computer-readable medium of claim 20 comprising the additional step of storing the decrypted content segment stripes in a storage device.

23. The computer-readable medium of claim 20 comprising the additional step of logging and communicating information to a central reporting and analysis framework

24. A node in a peer-to-peer network comprising:
an input interface module that receives a request for a content item from an end user;
a content manager module that retrieves a content profile for the content item from a secure content directory, wherein the content profile contains information relating to the location of a plurality of content segment stripes, each of which comprises a portion of the content item in encrypted form, each of the plurality of content segment stripes being located on a node in the peer-to-peer network;
a segment manager module that establishes a plurality of parallel data flows for retrieving the plurality of content segment stripes from the nodes on which each of the plurality of content segment stripes is located;
a reassembly module that creates a plurality of stripe queues for receiving the plurality of parallel data flows and retrieves the plurality of content segment stripes into the plurality of stripe queues substantially concurrently;
a decryption module that decrypts the content segment stripes and passes the decrypted content segment stripes to a player queue wherein the content segment stripes are reassembled into at least one content segment.

25. The node of claim 24 additionally comprising a insertion module that inserts advertising content from a into the at least one content segment.

26. The node of claim 24 wherein the decryption module stores the decrypted content segment stripes in a storage device.

27. The node of claim 24 wherein the content manager module additionally logs and communicates information to a central reporting and analysis framework

28. A method for transmitting content on a peer-to-peer network, comprising the steps:
receiving a content item from a content provider;
dividing the content item into a plurality of content segments;
encrypting each of the plurality of content segments;
dividing each of the plurality of encrypted content segments into at least one content segment stripe;
transmitting each of the at least one content segment stripes to one of a plurality of nodes on the peer-to-peer network,
wherein at least two of the at least one content segment stripes are transmitted to different nodes on the peer-to-peer network.
